(19) United States
(12) Patent Application Publication
(10) Pub. No.: US 2012/0056442 A1
(43) Pub. Date: Mar. 8, 2012

(54) ADJUSTABLE CONSOLE AND MODULAR DASH RAIL

(75) Inventors: William E. Stimel, Alexandria, OH (US); Logan Eric Mullinix, New Albany, OH (US); Keith A. Overton, Columbus, OH (US)

(73) Assignee: CVG MANAGEMENT CORPORATION, New Albany, OH (US)

(21) Appl. No.: 13/224,001

(22) Filed: Sep. 1, 2011

Related U.S. Application Data
(60) Provisional application No. 61/379,967, filed on Sep. 3, 2010.

(51) Int. Cl. B62D 25/14

(52) U.S. Cl. 296/70

(57) ABSTRACT

An adjustable and tilt-able display cluster and/or instrument panel (I/P) that allows operators of variable height and other physical attributes adjustability to position optimal angle best fit for their viewing is disclosed. The adjustability can also increase forward and peripheral visibility. Additionally, most any controls contained within the I/P reach items can be optimized by the adjustability.

### CROSS-REFERENCE TO RELATED APPLICATIONS

This application claims the benefit of U.S. Provisional Patent application Ser. No. 61/379,967 entitled “ADJUSTABLE CONSOLE AND MODULAR DASH RAIL” and filed Sep. 3, 2010. The entirety of the above-noted application is incorporated by reference herein.

### BACKGROUND

The interior of a truck's cab continues to evolve to include many features and amenities that enhance comfort of a driver or operator. For example, it is not uncommon for today's cab to be equipped with televisions, microwaves, Wi-Fi Internet access, etc. Additionally, many cabs are equipped with some of the finest leather seating and trim. Unfortunately, the instrument clusters and instrument panels (I/P) have remained somewhat sterile and lack adjustability.

As such, because the I/P within a truck's cab or cabin lacks adjustability, an operator can be limited in positioning their seat by lack of access to controls. Similarly, because today's I/Ps are not adjustable, oftentimes, an operator is unable to view some of the display panels when positioned in a certain manner. Thus, there is a need in the art for systems that enhance adjustability of instrument clusters and panels within a vehicle's (or truck's) cab.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises an adjustable display cluster and/or instrument panel (I/P). The adjustable display cluster and/or I/P can enhance safety, operator performance and comfort of an operator. The display cluster and/or I/P can tilt and pivot as desired. In aspects, the IPs and display clusters can tilt up/down as well as the console can pivot outward from the dash so as to enhance visibility and/or access by an operator and/or passenger. In addition to the displays mounted directly in front of an operator, the adjustable display and control clusters (e.g., I/Ps) can also be associated to the center console of trucks and other vehicles. These adjustable I/Ps offer operators of differing physical characteristics, e.g., operators of variable reach, adjustability to position optimal angle best fit for their view and reach. The adjustability can also increase forward and peripheral visibility. In aspects, both console stacks can articulate or rotate individually or not at all as desired. In aspects, the position can be swept, for example, from 0 to 70 degrees, allowing for either occupant in the front seat(s) easy access to the controls and or displays on either console stack.

In yet further aspects, an operator (or passenger) can position the I/P to most any angle (within acceptable) of range. The position can be retained in a memory for different drivers, times of day, etc. Also, the adjustability fits a broad spectrum of body types and delivers a most comfortable viewing angle and reach. Still further, the adjustability can allow for easy access to the “sleeper” area of the vehicle when stowed in a normal (or flat) position.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example adjustable console assembly in accordance with aspects of the innovation.

FIG. 2 illustrates an overhead view of an example instrument panel (I/P) assembly in accordance with aspects of the innovation.

FIG. 3 illustrates a perspective view of an example I/P assembly in accordance with aspects of the innovation.

FIG. 4 illustrates an alternative perspective view of an example I/P assembly in accordance with aspects of the innovation.

FIG. 5 illustrates an alternative perspective view of an example I/P assembly in accordance with aspects of the innovation.

FIG. 6 illustrates an example I/P assembly in accordance with aspects of the innovation.

FIG. 7 illustrates an example rotational arc in accordance with aspects of the innovation.

FIG. 8 illustrates an alternative perspective view of an example I/P assembly in accordance with aspects of the innovation.

FIG. 9 illustrates an alternative perspective view of an example I/P assembly in accordance with aspects of the innovation.

FIG. 10 illustrates an example I/P in a pivoted position in accordance with aspects.

FIG. 11 illustrates an example I/P in a pivoted position in accordance with aspects.

FIG. 12 illustrates an example modular track assembly in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

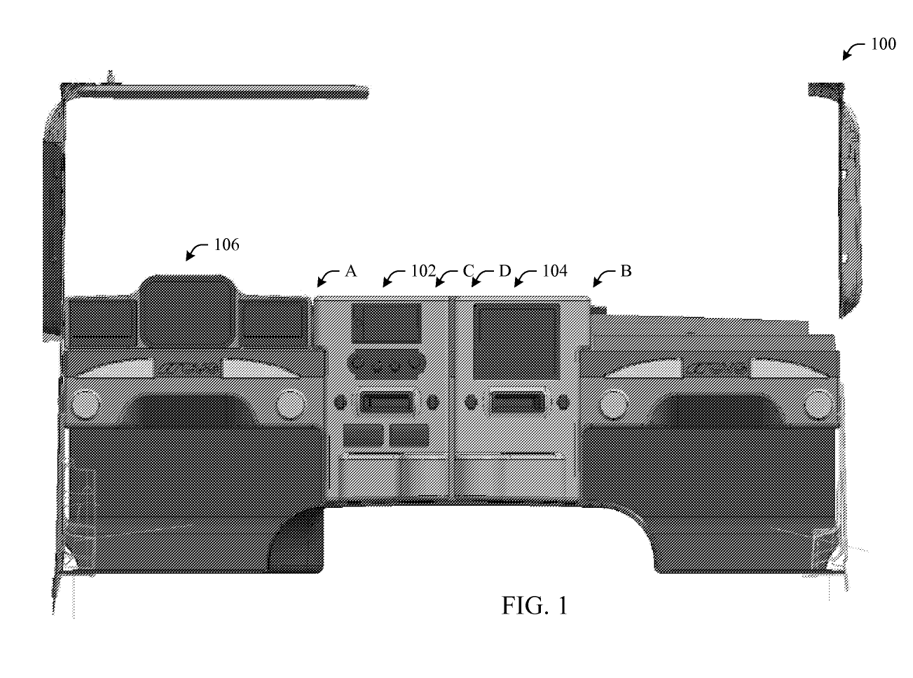

Referring initially to the drawings, FIG. 1 illustrates an example adjustable control and instrument panel (I/P) assembly 100 in accordance with aspects of the innovation. As will better understood upon a review of the figures that follow, the adjustable I/P can include two distinct adjustable assemblies 102, 104 and an instrument cluster (console) 106. All instrument panels and clusters 102, 104, 106 can pivot, tilt, slide or otherwise adjust to accommodate a user. In other words, in aspects, the panels and clusters 102, 104, 106 can pivot toward or away an operator. The cluster 106 can also tilt or adjust to right/left or closer/farther from an operator as desired. While the example described herein employs a separate adjustable I/P assembly for the operator (102) and passenger (104), it is to be understood that more or fewer assemblies (not shown) can be employed without departing from the spirit and/or scope of the innovation described herein.

Each of the adjustable I/Ps (102, 104) can include most any controls, including, but not limited to, climate controls, speed controls, lighting controls, audio controls, navigation, control ports, entertainment (audio/visual) controls, etc. Additionally, the adjustable I/Ps 102, 104 can optionally include ductwork for climate adjustment (e.g., air conditioning and heat). Still further, the panels 102, 140 can include storage compartments, cup/beverage holders, and other switches/controls as desired. Additionally, it is to be understood and appreciated that the assemblies 102, 104 can include modular compartments and/or components that enable an operator or passenger to personalize all or a subset of the controls as desired. For example, a beverage holder can be moved from one position to another in exchange for a change holding bin or the like.

In aspects, the adjustable IP panels 102, 104 are capable of independently swinging or pivoting in an arc-like pattern such that the units 102, 104 can be re-adjusted to better accommodate a user's reach and/or view. It is to be understood that ergonomic features and placement can be optimized using modeling software and other tools. The innovation described herein contemplates use of these software tools to optimize access, availability and comfort.

As shown in FIG. 1, each panel is capable of pivoting at a selected pivot point, e.g., ‘A’ or ‘B.’ In addition to the pivot points (A or B), aspects can employ additional adjustments, for example, slide mechanisms that adjust the I/Ps (102, 104) forward and back (and right to left) as desired. These and other adjustment mechanisms can be incorporated into aspects as desired and/or appropriate. Still further, additional pivot points can be employed (e.g., ‘C’ and ‘D’) so as to enhance pivoting and adjustment of each of the units 102, 104).

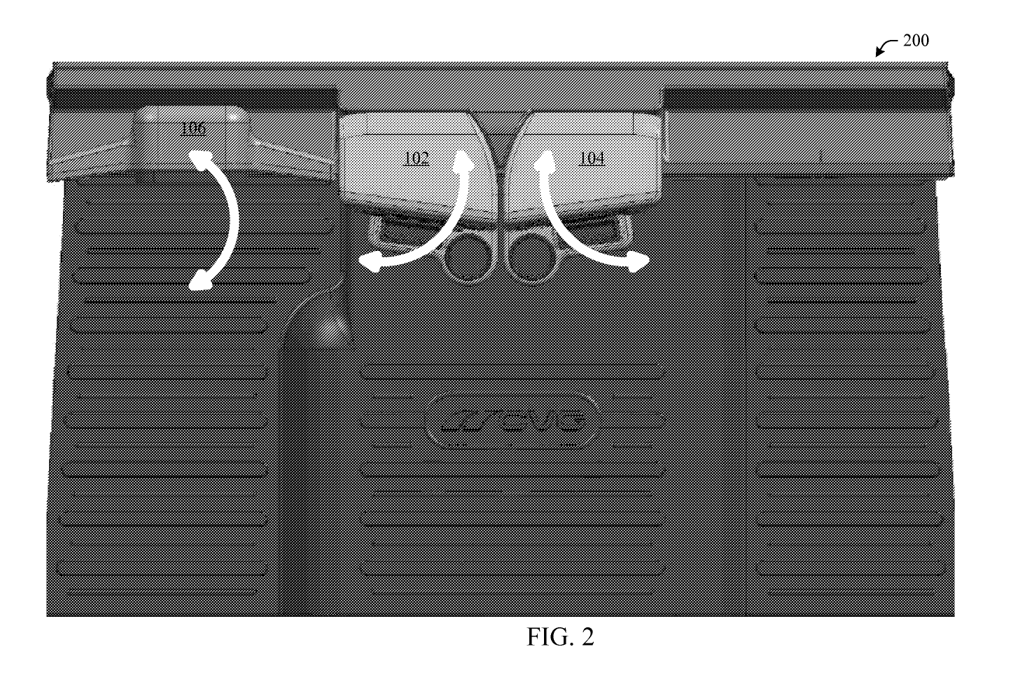

Referring now to FIG. 2, an overhead perspective view of an example adjustable I/P assembly 200 is shown in accordance with aspects of the innovation. As illustrated, the example assembly 200 includes two adjustable units 102, 104. Each of the units 102, 104 accommodates and is adjustable toward an operator (e.g., driver) and passenger of a vehicle such as a truck. In other words, unit 102 can pivot as shown toward an operator location while unit 104 can pivot toward a passenger as shown. While specific pivot points (A and B) are shown in FIG. 1, it is to be understood that other adjustment means can be employed without departing from the features, functions and/or benefits of the innovation. In addition to the console I/Ps 102, 104 pivot points, as shown in FIG. 2, the innovation also provides for the dash cluster 106 that can pivot up and down, right or left so as to accommodate various driver positions and sizes, as well as glare reduction scenarios.

For example, glare upon a screen or display (with respect to 102, 104 or 106) as well as glare upon side glass can be alleviated or reduced by the innovation. For instance, in the event that an instrument lighted display is glaring upon a side window thereby disturbing or impairing a driver or occupant, the innovation enables manual (as well as automatic) adjustment to compensate and alleviate these glares. As well, outside lighting sources which affect visual appearance of the instruments and controls can be alleviated (manually or automatically) by adjusting the unit's (102, 104, 106) positions.

In operation, circular or arc-shaped tracks or guides can be implemented beneath the adjustable I/Ps 102, 104. These guides or tracks (not shown) can control travel and adjustment to better accommodate a user. As will be understood, by adjusting the I/Ps 102, 140, a user's vision and/or reach to the controls and compartments thereon can be enhanced. As described above, tracks, guides and/or slides can be employed to enable adjustment in a right to left and/or forward and back position. Still further, aspects can employ height adjustments and tilt adjustments as appropriate and/or desired.

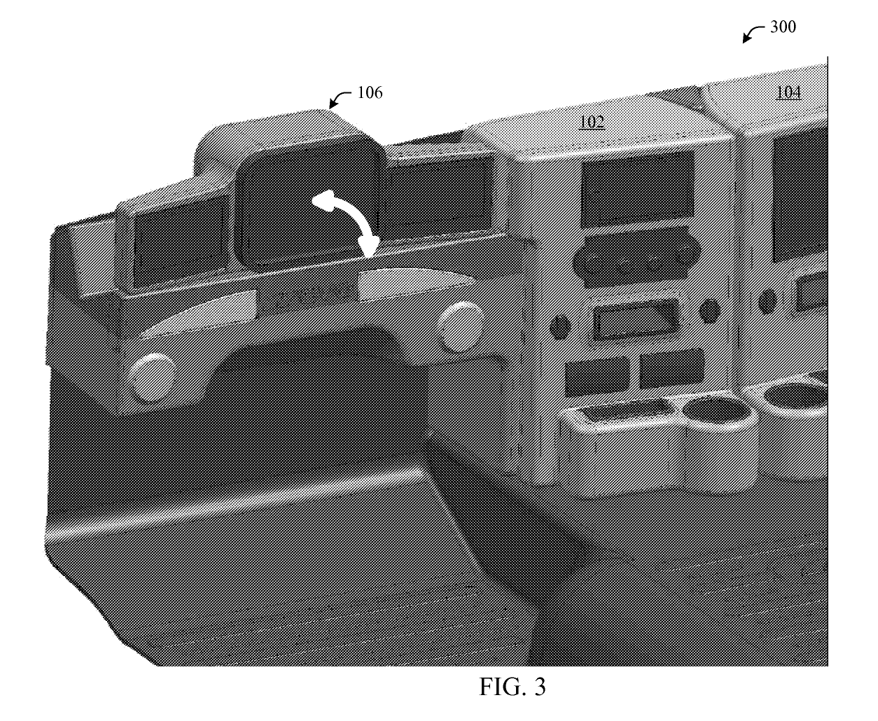

FIG. 3 illustrates a front perspective view of an adjustable I/P assembly 300 in accordance with aspects of the innovation. As shown, each of the adjustable I/Ps 102, 104 can be equipped with controls and/or storage compartments that enhance comfort and convenience to an operator and/or passenger. As illustrated, it is to be understood that individual panels (102, 104) can be designed specific as desired or appropriate. For example, an operator's I/P 102 may be equipped with lighting adjustments, cup holder, change holder, air conditioning, audio and/or navigation controls/touchscreen, and other controls that are conducive to operation of the vehicle or truck.

Similarly, the passenger's panel 104 can be equipped with conveniences to a passenger. In addition to some of the controls provided to an operator, the passenger's panel 104 can be equipped with entertainment (e.g., video) screens or the like. It is to be understood that the options are countless, all of which are to be included within the spirit and/or scope of the innovation described herein. Further, as described supra, a subset of the controls and amenities can be modular so as to enable personalization of the units 102, 104.

The consoles (102, 104, 106) can be manufactured of most any suitably rigid material including, but, not limited to plastics, composites, metals, alloys or the like. As well, if desired, the base material can be covered, e.g., with a leather, vinyl, etc. Still further, the guide tracks can employ rollers, bearings, etc. as appropriate to effect motion. It is to be appreciated that the motion can be manually or automatically (e.g., motorized) as appropriate or desired. While swivel motion or adjustment is described, it is to be understood that adjustment can be made in a vertical and/or horizontal motion (as well as directions between vertical and horizontal planes). As well adjustment can be made to raise or lower the units as well as to adjust near or away from an occupant position as desired.

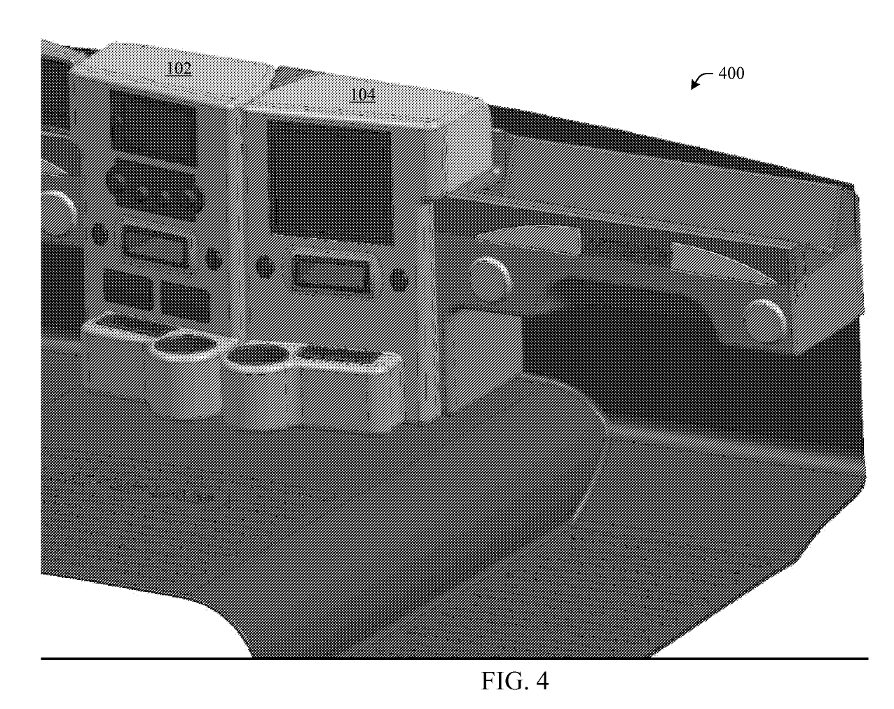

Turning now to FIG. 4, an alternative view 400 of an adjustable I/P assembly 400 is shown in accordance with aspects of the innovation. As described supra, each of the adjustable I/P assemblies (102, 104) can be separate (or partially overlapping) sets of controls and amenities. In other aspects, the I/Ps 102, 104 can be designed the same such that they are interchangeable, for example, for right-hand versus left-hand drive vehicles.

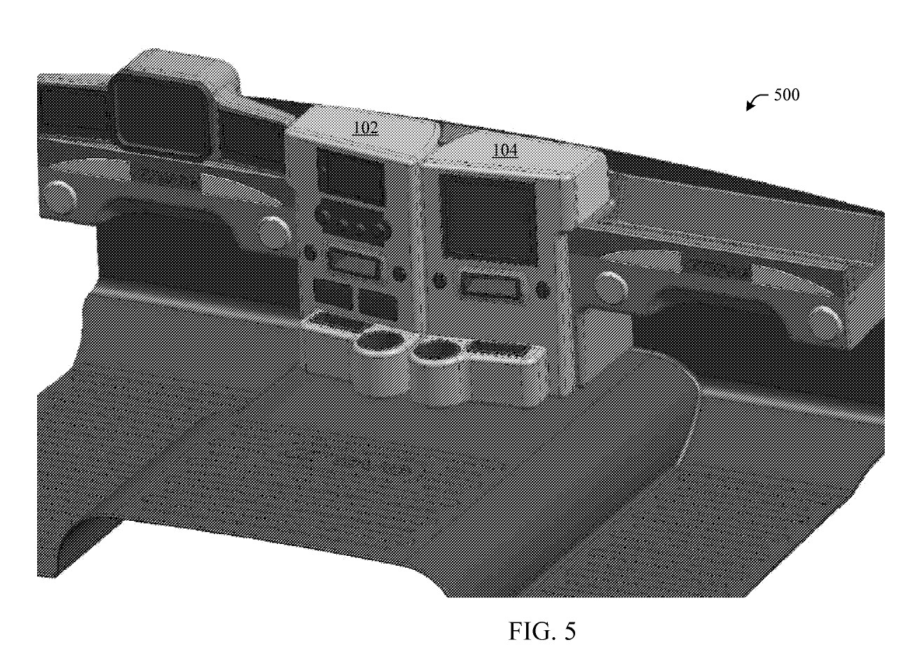

FIG. 5 illustrates yet another perspective view of an example adjustable I/P assembly 500 in accordance with aspects of the innovation. As will be understood, the adjustable I/P assemblies 102, 104 can swing out, pivot or otherwise adjust to accommodate access to an operator and/or passenger of a vehicle. These adjustable panels 102, 104 can be manually operated or motorized as desired. Upon reaching a desired position, the panels 102, 104 can be locked such that they cannot move in either (or any) direction. Locking can be effected by way of pins, latches, locks, friction means (brakes), or most any other suitable mechanism.

In one example, manually operated switches or latches can be employed to swing out each of the panels 102, 104 individually or in tandem. In operation, in aspects, specific latch positions can be pre-designated. In other aspects, a user can select a latch position as desired based upon a location within the range of travel.

In a motorized aspect, electrical switches (e.g., rocker switches), push-buttons, directional switches/controls and/or joysticks can be employed to adjust the position of the I/Ps 102, 104 as well as console 106. Similarly, desired positions of the panels 102, 104 (and console 106) can be pre-set and stored in a memory. Thus, a driver can select from a variety of pre-programmed positions. These pre-programmed positions can be set from driver to driver. As well, a driver can set different positions individually, e.g., day versus night. In this aspect, the units (102, 104, 106) can automatically adjust based upon the time of day. As described supra, sensors can be employed to manually adjust (or suggest adjustment) of the units 102, 104, 106.

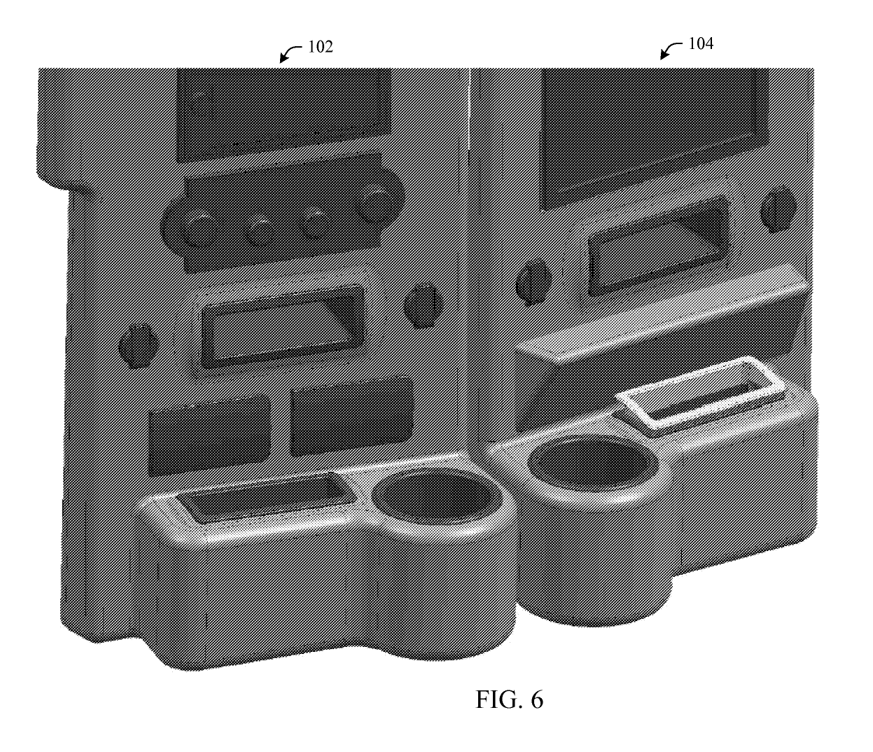

Referring now to FIG. 6, an alternative example of I/Ps 102, 104 is shown. As illustrated, each of the panels 102, 104 can employ specialized compartments and controls as desired or appropriate. Additionally, as shown, some or all of the inserts can be modular as preferred or by design. For instance, modular inserts can be specially designed and swapped by a user so as to personalize orientation of a particular I/P.

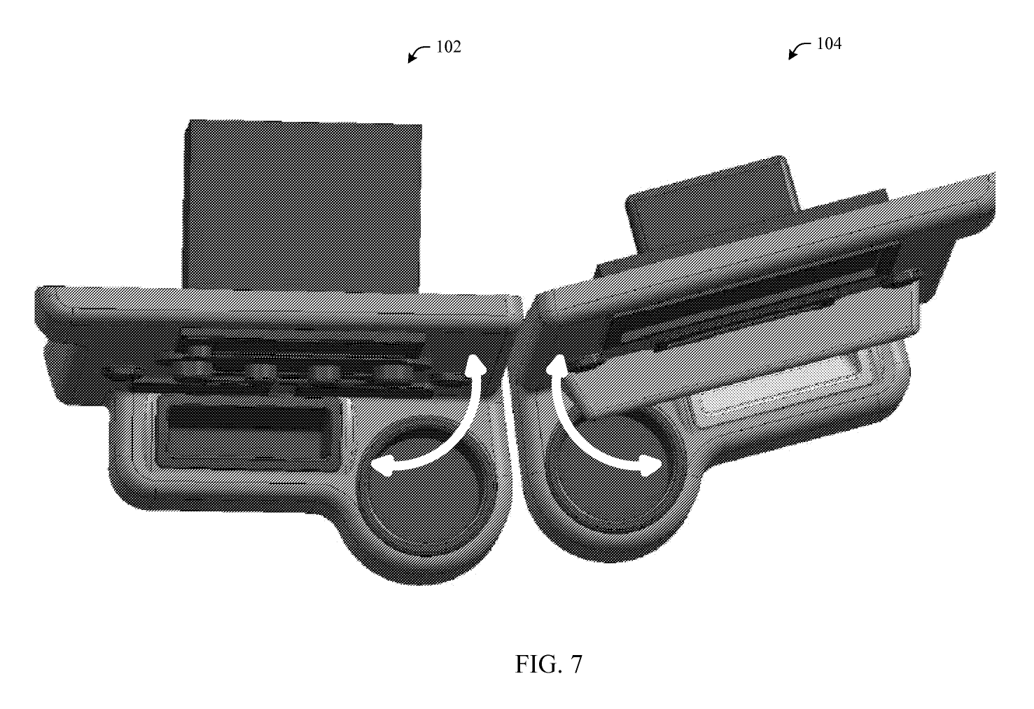

FIG. 7 illustrates an overhead view of an example I/P assembly in accordance with aspects of the innovation. As shown by the arrows in FIG. 7, each of the panels are capable of pivoting so as to provide a more conducive or efficient position for a user. As described above, a desired position can be stored or retained in a memory and selected by a user upon entry of a vehicle. Additionally, it is to be understood that the memory can be triggered electronically, for example, via an electronic key fob or the like. Moreover, sensors can be employed that detect presence and distance thereby automatically adjusting the console(s) 102, 104 in accordance therewith.

In specific aspects, the pivotable I/Ps 102, 104 can be equipped with a crash sensor such that, if a crash occurs, the pivoted I/Ps 102, 104 can automatically release (e.g., unlock) thereby providing unobstructed egress from a vehicle compartment. It will be appreciated that most any sensors, actuators, solenoids or the like can be employed to effect crash detection, release and/or motion.

In still other aspects, as described above, glare (or light) upon the I/Ps 102, 104, 106 can be detected and minimized as desired. In other words, the panels 102, 104, 106 can be equipped with sensors that automatically readjust the position, for example, should a glare factor be above a determined or desired threshold.

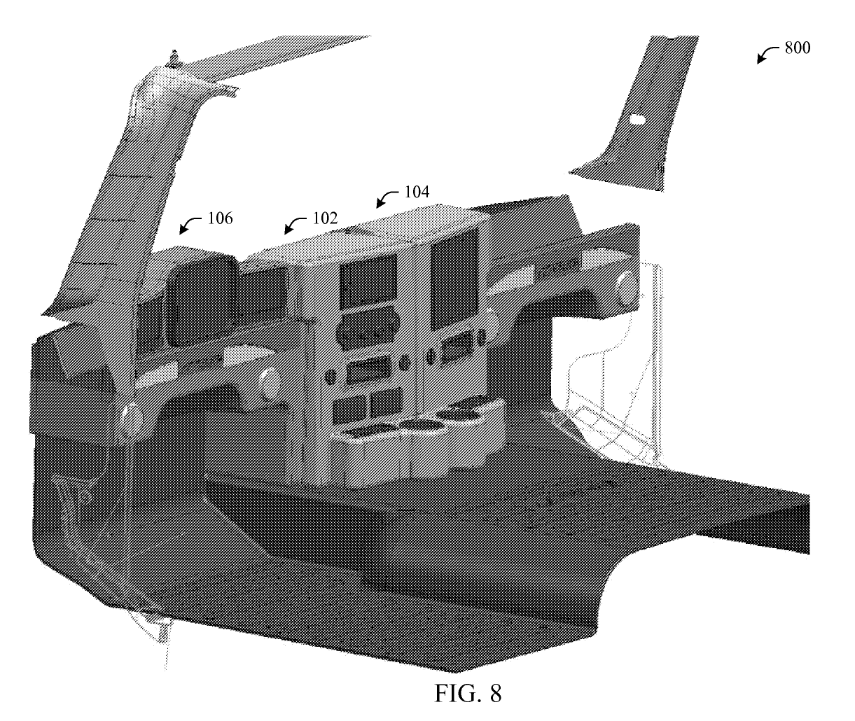

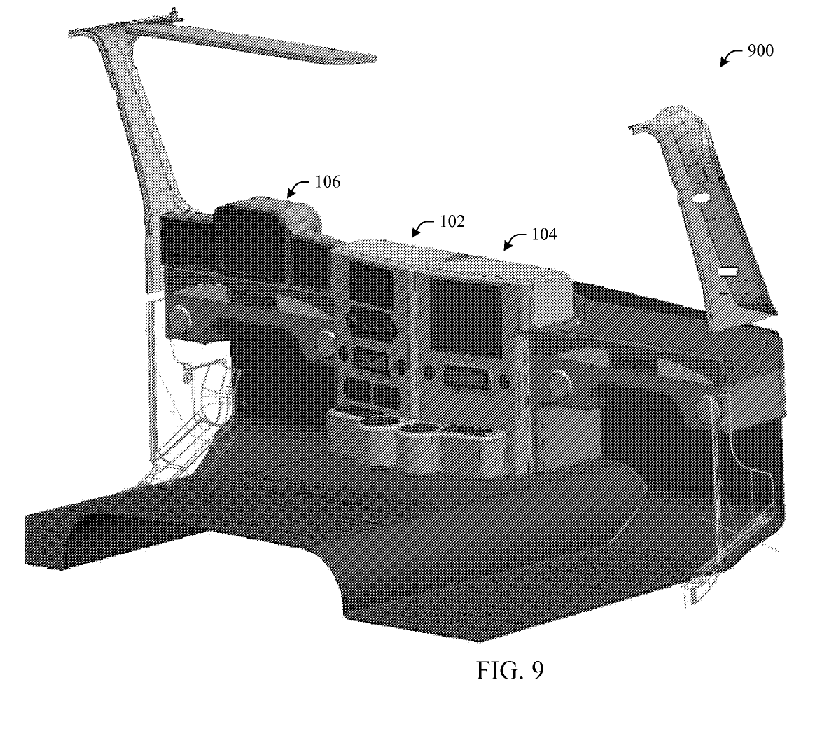

FIGS. 8 and 9 illustrate alternative views (800, 900) of adjustable I/Ps in accordance with aspects of the innovation. It is to be appreciated that these aspects are examples and not intended to limit the scope of the innovation in any manner. Rather, the size, orientation, configuration, set of inserts and controls, etc. are examples. It is contemplated that alternatives exist and are to be included within the spirit and/or scope of the innovation.

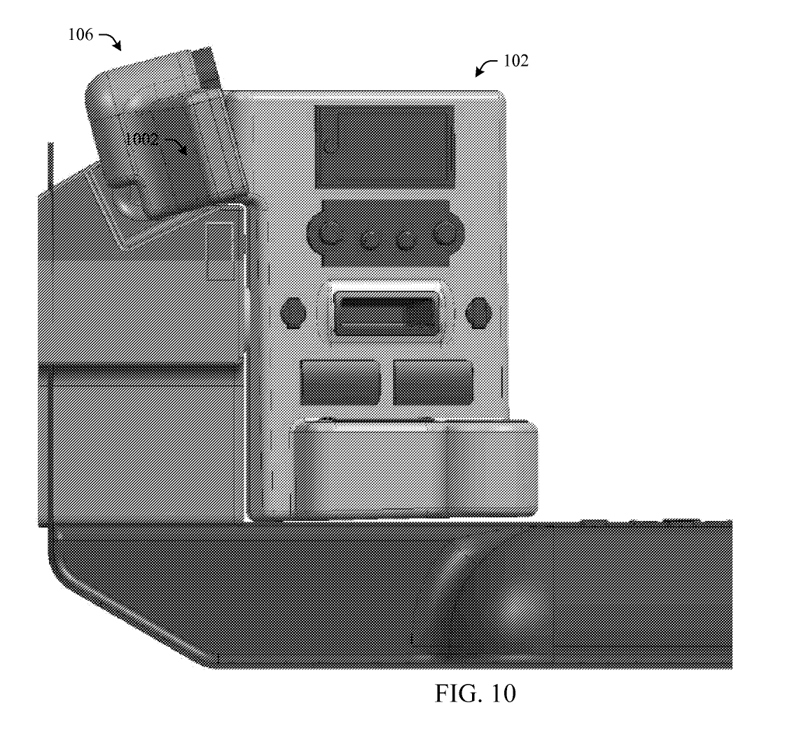

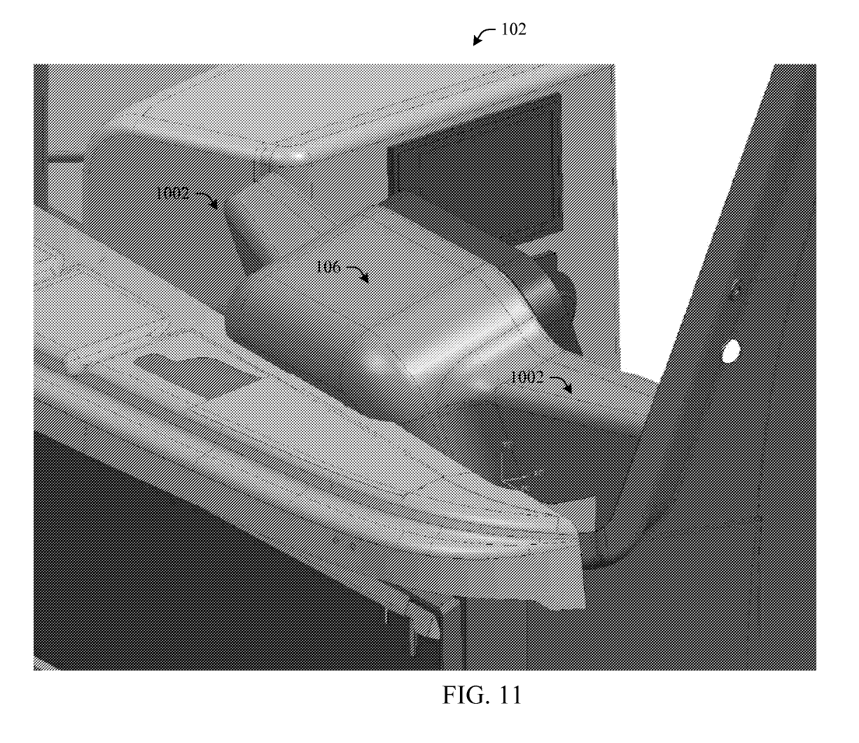

Continuing with the example described herein, FIGS. 10 and 11 illustrate an example adjustable I/P 102 in a pivoted position. In other words, as shown, panel 102 is shown pivoted toward an operator's location (in a left-hand drive vehicle). It is to be understood that the amount of pivot is merely an example and that the panel 102 can pivot more or less as desired or appropriate. As described above and can be appreciated, most any hinging or pivoting means can be used in aspects of the innovation to effect the arc-like motion of the panel(s) 102. In one example, a hinge and locking means (not shown) are employed. In other aspects, floor tracks or guides can be employed together with pivoting means to effect the arc-like travel. The console 106 can also pivot in most any direction (up/down, right/left, etc.). Additionally, the screens or visual panels and gauges within the panel 106 can independently toggle as desired so as to maximize an operator's experience. Still further, the panel 106 as shown can employ hinging means (not shown) within the “ears” 1002 or side panels of the panel 106. Here, each of the “ears” 1002 can swivel or hinge independently of each other as desired.

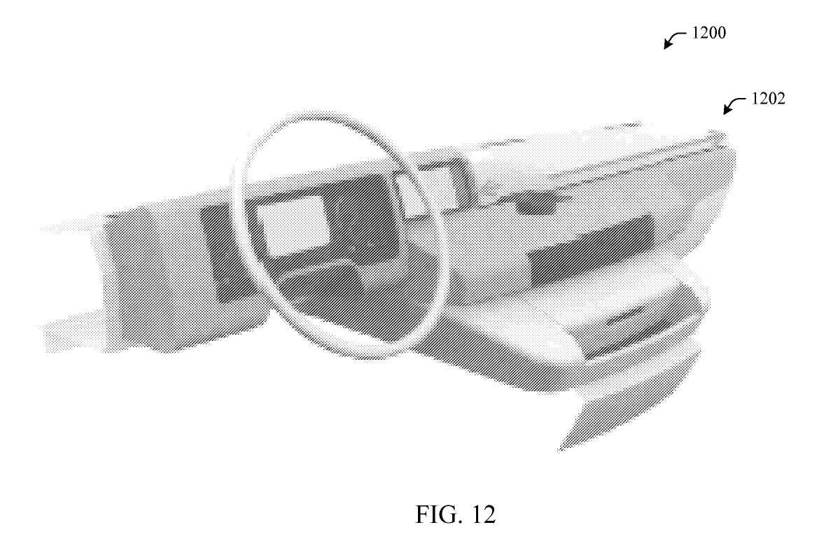

Referring now to FIG. 12, an example modular dash assembly 1200 is shown in accordance with aspects. As illustrated, the assembly 1200 includes a dash rail (or track, guide, etc.) 1202 that enables modular attachments to be slid, snapped or otherwise connected to the dash as desired. In aspects, the track or groove that can be employed to add modular devices, e.g., cup holders, phone holders, reading lamps, trays, etc. As will be appreciated, this guide rail 1202 concept can be incorporated into (or separate from) the adjustable I/Ps described with reference to FIGS. 1 to 11 herein. Further, while depicted above or in the traditional glove-box area, this rail (or multiple rails) can be installed at most any location about the dash assembly as appropriate or desired without departing from the spirit and/or scope of the innovation and claims appended hereto.

What has been described above includes examples of the innovation. It is, of course, not possible to describe every conceivable combination of components for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates console adjustment, comprising:
an instrument panel (I/P) assembly; and
a pivoting means fixedly attached to the I/P assembly, wherein the pivoting means facilities arc-like adjustment of the IP assembly.

2. The system of claim 1, further comprising a locking means that secures the pivoted I/P assembly in a desired position.

3. The system of claim 2, further comprising a motorized means that facilitates adjustment of the I/P assembly to the desired position.

4. The system of claim 3, further comprising a switching means that triggers control of the motorized means.

5. The system of claim 4, further comprising a memory that retains the desired position of the pivoted I/P assembly.

6. The system of claim 1, further comprising a sensor means that automatically releases the I/P assembly in an emergency situation.

7. The system of claim 1, further comprising a glare adjustment means that automatically tilts or pivots the I/P assembly upon detection of glare that exceeds a threshold.

8. The system of claim 1, further comprising a modular dash track that enables removable and adjustable attachment of a plurality of tools.

9. The system of claim 8, wherein the plurality of tools includes a cup holder, phone holder, change holder, and pen holder.

10. A console adjustment system, comprising:
one or more guide tracks; and
one or more instrument consoles configured to traverse along the one or more guide tracks.

11. The console adjustment system of claim 10, wherein each of the one or more instrument consoles comprise a plurality of modular inserts that are configured to accept a plurality of tools.

12. The console adjustment system of claim 10, further comprising a memory means configured to retain at least one position along the one or more guide tracks, wherein the at least one position is based in part upon a user preference.

13. The console adjustment system of claim 10, further comprising a roller system that facilitates traversal of the one or more consoles along the one or more guide tracks.

14. The console adjustment system of claim 10, further comprising a pivoting means that facilitates arc-like adjustment of the one or more consoles.

15. The console adjustment system of claim 14, further comprising a locking means that secures the one or more consoles in a desired position along the one or more guide tracks.

16. An instrument panel assembly, comprising:
a housing configured to retain one or more instrument modules; and
an adjustment mechanism that enables the housing to pivot to alternate positions, wherein each of the alternate positions alter a user's line of sight to each of the one or more instrument modules.

17. The instrument panel assembly of claim 16, wherein each of the one or more instrument modules are configured to independently pivot on a plurality of planes.

18. The instrument panel assembly of claim 16, further comprising a process and a memory that maintain a plurality of positions of the housing and the one or more instrument modules based at least in part upon a user preference.

19. The instrument panel assembly of claim 16, further comprising an anti-glare mechanism that detects light glare and automatically adjust the position of the housing to alleviate the light glare.

20. The instrument panel assembly of claim 19, wherein the anti-glare mechanism monitors light glare on a subset of the one or more instrument modules and, upon detection of the light glare, automatically adjusts a the subset of the one or more instrument modules.
